(19) United States
(12) Patent Application Publication
(10) Pub. No.: US 2026/0268798 A1
(43) Pub. Date: Sep. 10, 2026

(54) Resumption Motion STEM Learning Device

(71) Applicant: Matthew Schowalter, Port Washington, WI (US)

(72) Inventor: Matthew Schowalter, Port Washington, WI (US)

(21) Appl. No.: 19/351,844

(22) Filed: Oct. 7, 2025

Related U.S. Application Data
(60) Provisional application No. 63/769,512, filed on Mar. 10, 2025.

(51) Int. Cl. G09B 23/18

(52) U.S. Cl. CPC G09B 23/187

(57) ABSTRACT

This invention pertains to a STEM learning and educational tool in the form of a kit and a system that produces observable repeating patterns of forward and resumptive movement of a suspended mass object. The movement is observable, repeatable, measurable, controllable, and adjustable by the select interactions among magnetic, diamagnetic, and paramagnetic elements within a shared magnetic field.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### CROSS REFERENCE TO RELATED APPLICATIONS

This application is a nonprovisional utility patent application claiming benefit of its prior filed provisional patent application, Patent App. No. 63/769,512 (filing date Mar. 10, 2025), pursuant to 35 U.S.C. § 119(e).

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark office, patent file or records, but otherwise reserves all copyright rights whatsoever.

### FIELD OF THE INVENTION

A STEM learning and educational tool, specifically involving magnetic interactions.

### BACKGROUND

Magnets interact at the intersection between the laws of physics and chemistry. A magnet imparts upon its environment a magnetic field that interacts with free electrons within that field. The direct interaction of magnets and free electrons either attracts or repels chemically, or either adds or detracts physically by measure of electron force. The interactive relationship further imparts a tangential effect upon the surrounding environment. All matter embodies some degree of magnetism. However, the type and degree of magnetism will differ based on their material composition. There are several types of magnetism, each defined by how a material's constituent atoms' magnetic moments interact with an external magnetic field. One type of magnetism is described as diamagnetism. Diamagnetism manifests as a weak repulsion of magnetic fields. Diamagnetic materials are weakly repelled by a magnetic field. When a diamagnetic material is placed in a magnetic field, its electrons change their orbital motion, inducing a magnetic dipole moment in the opposite direction to the external field. Bismuth is the most diamagnetic element known. This means it's strongly repelled by magnetic fields and will create its own opposing magnetic field when placed in one. Bismuth's strong diamagnetism allows it to be levitated by magnets, a phenomenon called diamagnetic levitation, where the bismuth is pushed away from a magnet, creating a stable point where it can be suspended in midair. A second type is known as paramagnetism. Paramagnetism is a weak attraction to magnetic fields. This occurs when atoms have unpaired electrons whose magnetic moments are randomly oriented in the absence of a field. Oxygen is paramagnetic because its molecular orbital theory predicts two unpaired electrons in its ground state, giving it a magnetic moment that causes it to be attracted to a magnetic field. The third type is known as ferromagnetism. Ferromagnetism manifests as a strong attraction to a magnetic field and has the ability to become permanently magnetized. This occurs in materials like iron, nickel, and cobalt, where atomic magnetic moments strongly align with each other. Another known type of magnetism is ferrimagnetism. Similar to ferromagnetism, ferrimagnetic materials are attracted to magnetic fields and can be magnetized, but their atomic magnetic moments align in opposite directions, though with unequal strengths. Yet another type is known as antiferromagnetism. In this case, the atomic magnetic moments of the object align in opposing directions with equal strength, effectively cancelling each other out, resulting in no net magnetism. There is also superparamagnetism. This is a condition where ferromagnetic or ferrimagnetic particles lose their collective magnetic properties above a certain temperature. The earth produces its own magnetic field. This field is an electromagnet generated by the motion of molten iron in the outer core, not by permanent magnetism within the core itself.

There are also several known types of magnets in physical form. The first type is known as permanent magnets. Permanent magnets create their own persistent magnetic field. These types of magnets are able to retain their magnetic properties and produce a magnetic field without an external power source. The next type of magnet is known as a temporary magnet. These types of material become magnetic only when placed in a magnetic field and lose their magnetism once the field is removed. Yet another type is known as electromagnets. These are devices that produce a magnetic field when an electric current flows through them. The earth acts more like a giant electromagnet, with its magnetic field generated by electric currents in the liquid outer core. These currents, created by the movement of molten iron and nickel, produce a self-sustaining magnetic field, but the extreme heat of the core prevents permanent magnetization. Because the flow of molten metal changes, the Earth's magnetic field is not static, and its poles can even reverse over long periods

While these are all known qualities of each type of magnetic element, there are no known devices that can measure their interactions with each other in a standardized manner. Typical demonstrations of the magnetic relationship between a paramagnetic or a diamagmetic device with a magnet are presented separately. As can be found among non-patent literature, pre-recorded images show the interaction of bismuth with a magnet without limiting parameters to the range of motion, shape, or positioning of either element. The relationship of liquified oxygen to magnets is presented in similar manner, as rough demonstrations. The observed interactions are difficult to control in a manner that can be measured scientifically with scientific value. Scientific value is an attribute of any method of study by which observations may be repeated and varied, but within such a controlled environment that their relative value are mathematically comparable. There remains a need in the current industry for a device and system that standardizes the observable interactions between a paramagnetic, a diamagnetic, and a magnetic element within proximity of the same magnetic field. Such a device would be invaluable in the study of magnetic interactions and forces and in promoting scientific inquiry.

### BRIEF SUMMARY OF INVENTION

The invention herein relates to a device and system in the form of a STEM learning kit pertaining to the interactions between a paramagnetic, a diamagnetic, and a magnetic object. The kit of this invention is configured in such a way that a student may explore the interaction among magnetic, diamagnetic, and paramagnetic principles by adjusting the variable features of said kit. The kit of this invention are preferably comprised of the following elements: a magnet, an object that is diamagnet in relation to said magnet, a means for maintaining said diamagnetic object proximately from said magnet, a fluid element that is paramagnetic relative to said magnet (herein referred to interchangeably as the “paramagnetic element” or the “fluid element”), said fluid element is capable of being free flowing, may be in a solid or liquid phase, and surrounds said magnet and diamagnetic object. The paramagnetic element in this case is preferably, without limitation, oxygen, but may also be any fluid in gaseous or liquid phase that is either or both chemically or magnetically noninteractive with said diamagnetic object and is paramagnetic in relation to said magnet. Said diamagnetic object is preferably, without limitation, bismuth, but may also be any solid form elemental object that has a repelling or paramagnetic relation to a magnet. The quantity, concentration, dimension, size, and relative positioning of the elements of this invention are adjustable. The diamagnetic object may also be composed of composite material (a combination of diamagnetic and non-diamagnetic material or alternatively, a combination of different types of diamagnetic material), which may introduce additional observable variables in its relationships relative to said magnet. The ability to add or reduce variables to this STEM kit both tests and teaches the scientific principles of magnetism as well as teach the dimensions and bounds of the scientific method. The magnetic element may comprise any type of magnet as described herein, including magnetized material and the earth's generated magnetic field.

The system of this invention is a magnetic torsional pendulum. A torsional pendulum typically consists of a disk or mass attached to a string or thread that twists around its axis, exhibiting non-uniform rotational motion. When displaced and released from equilibrium, it oscillates rotationally around its axis. The tortion pendulum of this invention is unique in that it has an equilibrium position where the mass starts with no torque acting on it. It is the interactive forces of the magnet, diamagnetic, and paramagnetic elements that instigate the movement of the pendulum mass. Once equilibrium is broken, displacement occurs where the mass is twisted to a certain angle, creating torsional potential energy. The torsional potential energy of said pendulum mass reaches a peak where, when released, the mass experiences a restoring torque that moves it back towards its equilibrium position. The restoring torque motion is also herein referred to as resumptive motion. During oscillation between forward and resumptive motion, the mass overshoots the equilibrium position due to inertia, repeating the process and causing oscillatory motion. The torsional pendulum of this invention is designed to remain balanced when suspended by a thread or string. The mass element rotates due to magnetism when held on the thread. Rotational oscillations persist as long as a magnetic field is present that is surrounded by a paramagnetic element, such as ambient oxygen. Absence of said paramagnetic element within a magnetic field (or vice versa) will result in cessation of said forward and resumption motion. On average, it has been observed that the mass may rotate and counterrotate clockwise by over 30 degrees, occurring every few minutes. The range of oscillation would depending on variations of the elements of the device.

The system of this invention utilizes a form of non-uniform rotational motion, specifically diamagnetic resumption motion. Non-uniform rotational motion is characterized by variable angular velocity, where speed changes over time; angular acceleration, where the rate of angular velocity varies; non-constant torque; energy changes and fluctuations; and a complex path of motion. Diamagnetic resumption motion (DRM) is a form of this non-uniform rotational motion, using magnetism, diamagnetism, and paramagnetic oxygen to temporarily overcome external unbalanced forces while stopping and restarting motion continuously. DRM is defined by variable angular velocity, angular acceleration, non-constant torque, fluctuating rotational kinetic energy, a potentially non-circular path of motion, weak repelling forces from diamagnetism, strong attraction from magnetic fields, and weak attractive force from paramagnetic oxygen.

The three magnetic elements and factors that interact to cause a Diamagnetic Resumption Motion are as follows:

### Ferromagnetic Materials

Ferromagnetic materials contain unpaired electrons with magnetic moments that tend to align parallel to each other within regions called magnetic domains. When exposed to an external magnetic field, the domains align with the field, resulting in a strong attraction. Ferromagnetic materials work against diamagnetic materials, which causes rotational movement under certain circumstances. Examples comprise any of the following: permanent magnets, ferritic stainless steel, martensitic stainless steel, iron, nickel, cobalt, and their alloys, and any combinations thereof.

### Paramagnetic Oxygen

Oxygen (O₂), has unpaired electrons that cause these materials to be attracted to external magnetic fields. When exposed to a magnetic field, the magnetic moments of the unpaired electrons tend to align with the field, causing a weak attraction. This paramagnetic oxygen causes diamagnetic materials to rotate under certain circumstances.

### Diamagnetic Materials

They do not have unpaired electrons. Instead, they induce tiny magnetic fields that oppose the external magnetic field, causing a weak repulsion. Examples comprise any known diamagnetic material, including the following without limitation: plastic, glass, bismuth, copper, silver, lead, wood, pumice, water, lead, pyrolytic carbon, polypropylene acrylic, and superconductors in their superconducting state, and any combinations thereof. In the presence of a magnetic field, diamagnetic material (in particular bismuth) can cause a conductive object to rotate due to the Lorentz force acting on moving charges within the conductive object. The object experiences a force perpendicular to both its velocity and the magnetic field, resulting in rotational motion.

### BRIEF DESCRIPTION OF THE ILLUSTRATIONS

In order to facilitate an understanding of this invention, the preferred embodiments of the invention are illustrated in the drawings identified below.

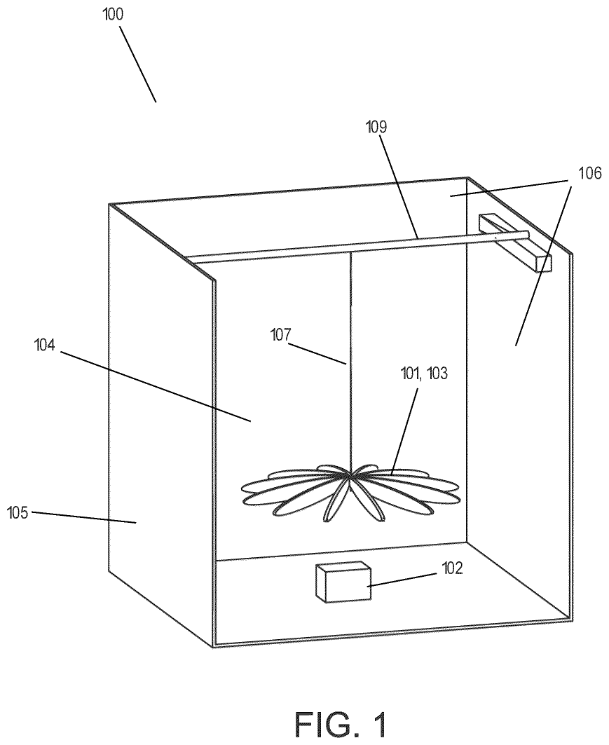

FIG. 1 is a front perspective view of an exemplary embodiment of the device of this invention.

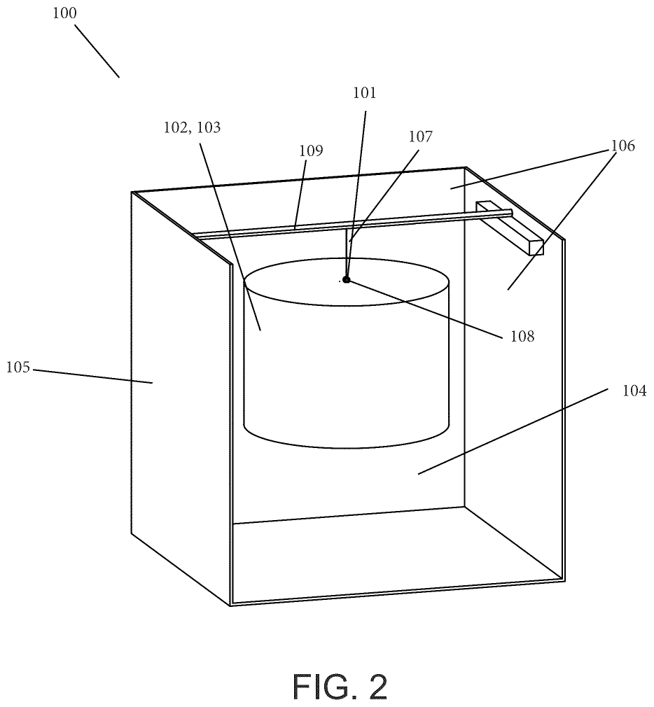

FIG. 2 is a front perspective view of an exemplary embodiment of the device of this invention.

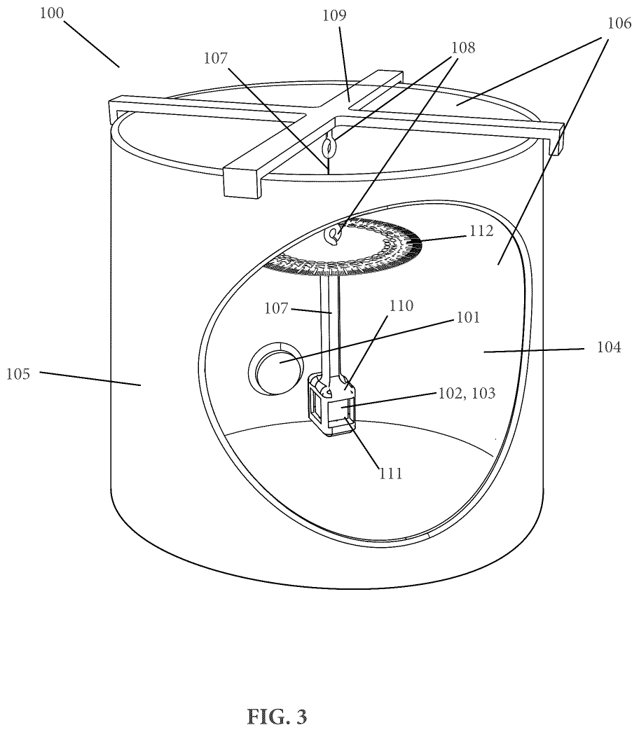

FIG. 3 is a front perspective view of an exemplary embodiment of the device of this invention.

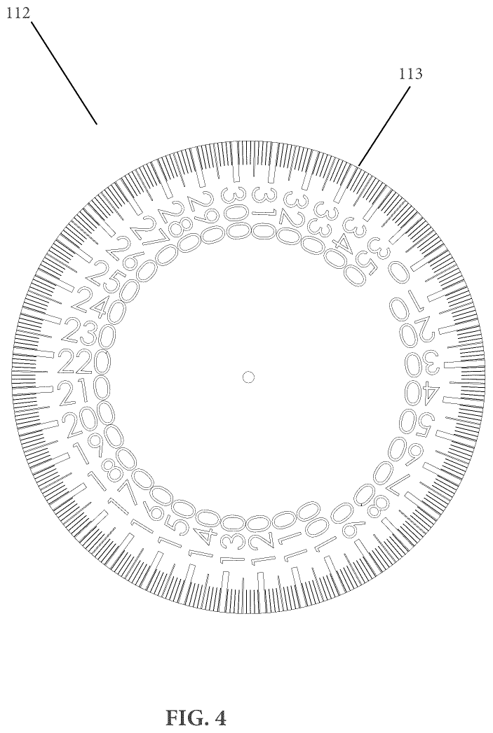

FIG. 4 is a front perspective view of an exemplary embodiment of the device of this invention in use.

### DETAILED DESCRIPTION OF INVENTION

While the foregoing specification illustrates and describes exemplary embodiments, it will be understood by those skilled in the art that various changes may be made and equivalents may be substituted for elements, thereof, without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

The invention herein relates to a device and system in the form of a STEM learning kit 100 pertaining to interactions between a paramagnetic element and a diamagnetic element within a magnetic field. The device of this invention is comprised of the following elements: a magnetic field that originates from a magnet or magnetized object 101; a diamagnetic object 102; a mass object 103 that may comprise a diamagnetic object or a magnetic or magnetized object; a paramagnetic element 104 that is fluid in nature and may be a gas or a liquid, or a combination of either physical forms; a means for suspending said mass object 103 within said magnetic field 101; said mass object 103 and said paramagnetic element are contained or held within said magnetic field. Said paramagnetic element 104 is preferably transparent to such a degree that the elements of this invention and their interactions are observable to the naked eye through said paramagnetic element 104. According to this preferred embodiment of the invention, either said magnet or magnetized object 101 or said diamagnetic object 102 is statically positioned in an affixed manner relative to each other. The other of the two mentioned elements is positioned proximately therefrom in a balanced and free-moving manner. According to this preferred embodiment of the kit, only one element, the mass object 103, may move in response to the magnetic interactions among the kit elements within the magnetic field.

The aforementioned elements of this invention may be contained within or without an external housing or container element 105. Said elements may be coordinated together in a self supported manner as a kit without a surrounding housing element 105, which exposes said kit elements to the ambient environment. Alternatively, said elements may be held within a surrounding container or housing element 105. Note that said container or housing element may be referred to interchangeably as either said housing element 105 or said container element 105. Said housing element 105 provides an enclosure that surrounds the elements of said kit. Said housing element 105 is comprised of material that is chemically inert, non-magnetic, diamagnetic, or any combination thereof. Diamagnetic material of said housing element may comprise any known diamagnetic material, including the following without limitation: bismuth, pyrolytic carbon, silver, copper, lead, wood, pumice, water, and plastics such as polypropylene and acrylic. The material of said housing element 105 is preferably a hard durable material that may be organic or inorganic in nature, or any combination thereof. Said housing element 105 may provide at least one or more openings 106 to the external ambient environment. Said one or more openings 106 allow for a free exchange of air with the external ambient environment. Said one or more openings may be a permanent opening or alternatively, closeable by manner of an adjustable or removable door, window, cap, or any combination thereof. The size, dimension, and shape of said one or more openings 106 may be predesigned to be static and nonchangeable in nature, adjustable, or a combination thereof. The size, dimension, and shape of said one or more openings will facilitate the direction, quantity, and speed of air or fluid exchange between the space within said housing element 105 and the external ambient environment. The flow of ambient air 104 into the internal space within said housing element carries with it oxygen gas, which is a paramagnetic fluid 104. A continual exchange of air between the external and internal environments of said housing element will facilitate continual paramagnetic interactions with the elements of said kit as it is fed a continual source of oxygen. A restriction of said flow will result in a decrease of paramagnetic interactions with the elements of said kit. The design of said housing element 105 may provide functional benefits while also providing aesthetic appeal and artistic distinction.

The paramagnetic element 104 of this invention comprises any type of gas or liquid material that is physically fluid and may be in the form of an element, molecule, or compound. Said paramagnetic element 104 has unpaired electrons that interact with the magnetic field of said magnet or magnetized object 101. The unpaired electrons will cause said paramagnetic element to be weakly attracted to an external magnetic field. Examples of paramagnetic gases 104 include the following without limitations: oxygen, nitric oxide, sulfur, boron, and compounds in the group of nitrogen oxides. Paramagnetic elements 104 of this invention in the form of liquid may comprise any of the following without limitation: liquid oxygen, solutions containing paramagnetic ions such as manganese (II) salts, manganese (II) sulfate or chloride. According to this invention, said paramagnetic element 104 is accessible and contactable with the magnetic field of said magnet or magnetized object 101. The quantity or concentration of paramagnetic elemet 104 that is accessible to said magnet or magnetized object 101 may be controlled either by the size, dimension, or shape of the housing element 105 that affects the manner of flow therein. Alternatively, the quantity or concentration of paramagnetic element accessible to said magnet or magnetized object 101 may be controlled by the manner of a directed flow from a concentrated source through a channel or pipe. The paramagnetic element surrounds and interacts with the magnetic field of said magnet or magnetized object 101, which exerts a tangential force onto its surrounding environment and is experienced by the proximately positioned mass object 103. The exerted force will be felt by said mass object 103, resulting in its movement according to the degree and angle of the exerted force. Said paramagnetic element 104 is preferably transparent to the naked eye to such a degree that the elements of this invention are visible therethrough.

Said diamagnetic object 102 is preferably, without limitation to, bismuth, but may also be any type of solid form elemental object that has a repelling or diamagnetic relation to a magnet. Said diamagnetic object, such as bismuth, will naturally be repelled by a magnet. When placed within a magnetic field or adjacent to a magnetic or magnetized object 101, repelling forces act against the diamagnetic object 102, creating a weak torque effect.

A feature of this invention involves the repelling interactions between the magnetic field generated from a magnetic source 101, the paramagnetic element 104, and the diamagnetic object 102, which should instigate oscillating movement of the suspended mass element. The mass object 103 is positioned in a suspended manner within the magnetic field and held by any of the following types of suspension material 107: a wire, string, rope, chain, line, strap, cord, band, stick, pole, shaft, or any combination thereof. The suspension element may comprise a connecting element 108, such as a hook, that is attached to the top end of said mass object 103 and optionally to the top end of said suspension material 107. The connection between the connecting element 108 (i.e. hook), the suspension material 107 (i.e. wire), and mass object 103 would result in its suspension within said magnetic field. These interconnected elements may further be attached to a support structure 109 comprising a series of one or more rods. Said support structure 109 may be self-supporting or alternatively, supported by the housing element 105. The support structure 109 may comprise one or more vertical rod or horizontal rod structure, or any combinations thereof. Said support structure 109 may further comprise one or more intersecting rods. The mass object that is attached to said wire element 107 and said hook element 108 may be detachably connectable to the support structure 109 and suspended within the magnetic field. The spatial location and distance between the mass object within the kit or within the magnetic field are adjustable by adjustment of the suspension elements, the support structure, or any combinations thereof. The length of said wire element may also be adjustable within the kit. Adjustment to these features introduces additional experimental variables for study and observation. The size, mass, and density of said diamagnetic object 102 or said magnet or magnetized object 101 may also be varied for additional observable dimensions.

Varying these features may be achieved by having different interchangeable sizes and shapes of the kit elements.

Yet alternatively, said mass object 103 may be held within a small hollow container 110. Said small hollow container 110 functions to hold said mass object 103 fully in place within the magnetic field. Said small hollow container 110 preferably provides at least one or more openings 111 to allow airflow therethrough, if the mass object 103 held within is a magnet or magnetized element 101. Said small hollow container 110 may comprise a wall type or cage type housing wherein the thickness of said wall or cage type material is thin enough to not fully nullify or completely inhibit the magnetic interaction of said mass object 103 with the magnetic field.

Another element of said kit may comprise a measuring device 112. Said measuring device contains spatial and angular markings 113 whereby rotational distance, speed (distance divided by time), and angular change is measurable. Said measuring device may be permanently or removably attached to another element of the kit of this invention, including: the housing device; the magnet or magnetized object; the diamagnetic object, or the suspension element; or any additional element not already mentioned herein that is introduced into said kit; or any combination thereof. According to a preferred embodiment, the measuring device 112 may comprise a circular or radial plate 112 containing incremental spatial markings 113. Said radial plate may be centrally positioned on said suspension element and above the mass object, moving with both suspension element and mass object relative to the magnetic interactions. According to this embodiment, the incremental markings are disposed along the perimeter edge of said plate 112. A total of 360 markings 113 span the entire radius of said circular plate, each marking having equal-distance from its adjacent marking throughout the plate. These markers 113 measure relative angular distance at the perimeter edge of said circular plate. The size of said circular plate may increase, whereby the incremental distance between each of said 360 markers 113 along the perimeter edge will proportionally increase, but wherein the vector angle radiating from the center of said circular plate and between any of such markers on said plate will not change with the varying circumference of said plate. The circular plate of said measuring device may be centrally positioned on said wire element and held together with the free-moving suspended element of this invention. The two commonly attached elements (said circular plate 112 and suspended mass object 103) are tandemly attached and tandemly moving together on said wire element. Additional markers or measuring devices may be added to or proximately to said kit in order to expand the measurable dimensions of observable magnetic interactions of the kit.

The mass object 103 may comprise a diamagnetic element 102 such as bismuth or plastic. Alternatively, the mass object 103 may also comprise a magnetic or magnetized element 101 such as a permanent magnet or a ferrous material (i.e. stainless steel) which is naturally and weakly magnetized by the earth's magnetic field to become ferromagnetic. The mass object 103 may also be any combination of elements that forms a composite material that interacts according to the magnetic, diamagnetic, and paramagnetic relationships described herein.

The device and system according to an alternative embodiment of FIG. 1 comprises a housing element 105, a mass object 103 that is a ferromagnet 101, a piece of bismuth 102, open to ambient air and oxygen flow 104. The housing element 105 is made from Polyethylene Terephthalate (PET) or acrylic plastic for easy visibility. At the bottom of the housing element is the diamagnetic element 102, comprising a piece of bismuth 102. The interaction between paramagnetic element (oxygen), the ferromagnetic 101 mass object (103), and the bismuth 102 element causes the mass object 103 to oscillate in a measurable forward and resumptive manner. The ferromagnetic 101 mass object 103 may comprise piece of stainless steel wool. The mass object 103 may be suspended by manner of a thread 107 attached to a support structure 109.. The stainless-steel wool is magnetized by the earth's magnetic field. It has unpaired electrons with magnetic moments that tend to align parallel to each other within regions called magnetic domains. When exposed to an external magnetic field (the earth's magnetic field), the domains align with the field, resulting in a strong attraction. The bismuth piece 102 on the bottom does not have unpaired electrons. Instead, they induce tiny magnetic fields that oppose the external magnetic field, causing a weak repulsion. When exposed to a magnetic field, the magnetic moments of the unpaired electrons tend to align with the field, causing a weak attraction, which results in rotation of the movement device.

The device and system according to an alternative embodiment of FIG. 2 comprises a housing element 105, a mass object 103 that is a diamagnetic plastic object 102, a ferromagnetic object 101, and the paramagnetic element comprising ambient air and oxygen flow 104. The mass object 103 is held by a string 107 and support structure 109, attached to a metal eye hook 108. The support structure 109 is seated over the housing element 105 with the suspension material 107 and the mass object 103 held within the internal space of the housing element 105.

The eye hook element 108 is magnetized by the earth's magnetic field and has unpaired electrons with magnetic moments that tend to align parallel to each other within regions called magnetic domains. When exposed to an external magnetic field such as the earth's magnetic field, the domains align with the field, resulting in a strong attraction. The plastic movement device does not have unpaired electrons. Instead, they induce tiny magnetic fields that oppose the external magnetic field, causing a weak repulsion. When exposed to a magnetic field, the magnetic moments of the unpaired electrons tend to align with the field, causing a weak attraction, which results in rotation of the movement device.

The device and system according to an alternative embodiment of FIG. 3 comprises a housing element 105, a mass object 103 that is a paramagnetic element (i.e. bismuth) 102, a permanent magnet 101, and a paramagnetic element comprising ambient air and oxygen flow 104. The housing element 105 is made of Polyethylene Terephthalate (PET) or acrylic plastic for easy visibility. The magnet 101 is a strong N52 neodymium magnet with north facing up. Bismuth 102 is extremely diamagnetic and resists the magnetic forces of the magnetic and from earth. The mass object is held within a small hollow container 110, attached to a shaft 107, that is further attached to thread 107 and to an eye hook element 108. The suspension material 107 is attached to a support structure 109, which is seated over the housing element 105. The oscillation of the mass object is due to how the magnet has unpaired electrons with magnetic moments that tend to align parallel to each other within regions called magnetic domains. When exposed to an external magnetic field, the domains align with the field, resulting in a strong attraction. The bismuth does not have unpaired electrons. Instead, they induce tiny magnetic fields that oppose the external magnetic field, causing a weak repulsion. When combined with the paramagnetic oxygen, which has unpaired electrons, these materials become attracted to external magnetic fields. When exposed to a magnetic field, the magnetic moments of the unpaired electrons tend to align with the field, causing a weak attraction, which results in rotation of the mass object. A measuring device 112, in the form of a circular plate with equal distant markings 113, is attached to the suspension element and rotates in tandem therewith.

Having fully described at least one embodiment of the present invention, other equivalent or alternative methods according to the present invention will be apparent to those skilled in the art. The invention has been described by way of summary and illustration. The specific embodiments disclosed in the above drawings are not intended to be limiting. Implementations of the present invention with various different configurations are contemplated as within the scope of the present invention. The invention is thus to cover all modifications, equivalents, and alternatives falling within the spirit and scope of the following claims.

1. A STEM learning and educational tool kit comprising:
a magnetic field generated by a magnet or a magnetized object,
a diamagnetic element,
a paramagnetic element,
a mass object,
said mass object is suspended on a suspension element,
said mass object comprising a magnet, a magnetized object, or a diamagnetic element,
said paramagnetic element comprising a liquid, a gas, or a combination thereof,
said mass object, diamagnetic element, and paramagnetic element are positioned together within said magnetic field.

2. A STEM learning and educational tool kit according to claim 1 wherein said suspension element comprises: a suspension material, a hook element, and a support structure.

3. A STEM learning and educational tool kit according to claim 1 is contained within a housing element.

4. Said housing element of claim 3 is composed of diamagnetic material and is a diamagnetic element.

5. A STEM learning and educational tool kit according to claim 1 wherein said paramagnetic element is Oxygen.

6. A STEM learning and educational tool kit according to claim 1 further containing a measuring device.

10. A STEM learning and educational system comprising a kit according to claim 1 wherein the magnetic field, the paramagnetic element, and the diamagnetic element are adjustable within said kit and wherein the interaction between the magnetic field, the paramagnetic element, and the diamagnetic element on the mass object is adjustable, observable, and measurable.

11. A system of STEM learning comprising a kit according to claim 1 wherein the frequency, direction, angular degree, and circumferential length of radial rotation of said diamagnetic object above said magnet is measurable by said measuring element.
